(19) United States
(12) Patent Application Publication
(10) Pub. No.: US 2020/0142413 A1
(43) Pub. Date: May 7, 2020

(54) CONFIGURABLE ILLUMINATION ON REGION OF INTEREST FOR AUTONOMOUS DRIVING

(71) Applicant: Pony.ai, Inc., Fremont, CA (US)

(72) Inventors: Bowen Zheng, San Jose, CA (US); Xiang Yu, Santa Clara, CA (US); Sinan Xiao, Mountain View, CA (US); Hao Song, Sunnyvale, CA (US); Tiancheng Lou, Milpitas, CA (US); Jun Peng, Fremont, CA (US)

(21) Appl. No.: 16/179,074

(22) Filed: Nov. 2, 2018

(51) Int. Cl. G05D 1/00; G05D 1/02; B60W 10/18; B60W 10/20; B60W 10/04

(52) U.S. Cl. CPC G05D 1/0094; G05D 1/0088; G05D 1/0246; B60W 10/18; B60W 30/09; B60W 10/04; G05D 1/0214; G05D 2201/0213; B60W 10/20

(57) ABSTRACT

A system included and a computer-implemented method performed in an autonomous-driving vehicle are described. The system performs: determining a region of interest (RoI) for processing images for an autonomous driving operation; determining an illumination condition for illuminating the determined RoI based on the determined RoI; and illuminating the determined RoI according to the determined illumination condition as the autonomous-driving vehicle travels.

### BACKGROUND

Autonomous-driving vehicles such as vehicles that autonomously operate with limited human inputs or without human inputs are expected in various fields. Since autonomous-driving operations of such autonomous-driving vehicles may significantly rely on image data obtained by image sensing devices, quality of the image data may be highly important for safer and more efficient autonomous-driving operations. One way to obtain good-quality image data may involve sufficient illumination on objects to be image-captured. It would be beneficial to provide efficiently providing sufficient illumination on objects to be analyzed for autonomous-driving operations.

These and other issues are addressed, resolved, and/or reduced using techniques described herein. The foregoing examples of the related art and limitations related therewith are intended to be illustrative and not exclusive. Other limitations of the related art will become apparent to those of skill in the relevant art upon a reading of the specification and a study of the drawings.

### SUMMARY

Described herein are a system included in and a computer-implemented method performed in an autonomous-driving vehicle. The system includes one or more processors; and a memory storing instructions that, when executed by the one or more processors, cause the one or more processors to perform an operation.

In one embodiment, the instruction causes the one or more processors to: determine a region of interest (RoI) for processing images for an autonomous driving operation; determine an illumination condition for illuminating the determined RoI based on the determined RoI; and illuminate the determined RoI according to the determined illumination condition as the autonomous-driving vehicle travels.

In some embodiments, the determining the RoI for processing images for the autonomous driving operation may comprise: capturing an image; determining a potential object to be focused in the captured image; determining a predicted traveling path of the autonomous-driving vehicle; determining a predicted moving path of the potential object; and determining the RoI and a shift of the RoI based on the predicted traveling path of the autonomous-driving vehicle and the predicted moving path of the potential object, such that the potential object stays within the RoI.

In some embodiments, the determining the potential object to be focused in the captured image may comprise determining a type of the potential object to be focused. The determining the illumination condition may comprise determining an intensity of illumination based on the type of the potential object. In some embodiments, the determining the RoI for processing images for the autonomous driving operation further may comprise determining a distance to the potential object. The determining the illumination condition may comprise determining at least one of an intensity of illumination and an illumination angle based on the distance to the potential object.

In some embodiments, the determining the illumination condition may comprise determining an illumination direction, such that the illumination stays illuminating the RoI. In some embodiments, illumination may include a plurality of light emitting devices directed to different directions. In some embodiments, the determining the illumination condition may comprise selecting one or more light emitting devices to be activated from the plurality of light emitting devices, such that the illumination stays illuminating the RoI.

In some embodiments, the determining the RoI for processing images for the autonomous driving operation may comprise: determining a shift of a field of view (FoV) of a camera as the camera pans and/or tilts; and determining the RoI and a shift of the RoI, such that the RoI stays within the FoV of the camera.

In some embodiments, the instruction may cause the one or more processors to: capture images in the RoI illuminated according to the determined illumination condition; detect one or more objects in the RoI; determine a vehicle behavior based on the one or more detected objects; and perform an autonomous driving operation according to the determined vehicle behavior. In some embodiments, the vehicle behavior may include at least one of braking, accelerating, and steering of the autonomous-driving vehicle. In some embodiments, the vehicle behavior may include at least one of light signaling and sound signaling.

### BRIEF DESCRIPTION OF THE DRAWINGS

Certain features of various embodiments of the present technology are set forth with particularity in the appended claims. A better understanding of the features and advantages of the technology will be obtained by reference to the following detailed description that sets forth illustrative embodiments, in which the principles of the invention are utilized, and the accompanying drawings of which:

FIG. 1 is a schematic diagram depicting an example of an autonomous-driving vehicle system according to an embodiment.

FIG. 2 depicts a flowchart of an example of a method for operating an autonomous-driving vehicle system.

FIG. 3 depicts a flowchart of an example of a method for determining a region of interest (RoI) for processing images for an autonomous driving operation.

FIG. 4 is a block diagram that illustrates a computer system upon which any of the embodiments described herein may be implemented.

### DETAILED DESCRIPTION

In the following description, certain specific details are set forth in order to provide a thorough understanding of various embodiments of the invention. However, one skilled in the art will understand that the invention may be practiced without these details. Moreover, while various embodiments of the invention are disclosed herein, many adaptations and modifications may be made within the scope of the invention in accordance with the common general knowledge of those skilled in this art. Such modifications include the substitution of known equivalents for any aspect of the invention in order to achieve the same result in substantially the same way.

Unless the context requires otherwise, throughout the present specification and claims, the word “comprise” and variations thereof, such as, “comprises” and “comprising” are to be construed in an open, inclusive sense, that is as “including, but not limited to.” Recitation of numeric ranges of values throughout the specification is intended to serve as a shorthand notation of referring individually to each separate value falling within the range inclusive of the values defining the range, and each separate value is incorporated in the specification as it were individually recited herein. Additionally, the singular forms “a,” “an” and “the” include plural referents unless the context clearly dictates otherwise.

Reference throughout this specification to “one embodiment” or “an embodiment” means that a particular feature, structure or characteristic described in connection with the embodiment is included in at least one embodiment of the present invention. Thus, the appearances of the phrases “in one embodiment” or “in an embodiment” in various places throughout this specification are not necessarily all referring to the same embodiment, but may be in some instances. Furthermore, the particular features, structures, or characteristics may be combined in any suitable manner in one or more embodiments.

Various embodiments described herein are directed to a system included in an autonomous-driving vehicle (or simply autonomous vehicle) and a computer-implemented method performed in an autonomous-driving vehicle. In a specific implementation, the system and the computer-implemented method are intended to generate illumination toward an object that is likely to be relevant in performing autonomous-driving operations, such as pedestrians, vehicles, and animals. The technology in certain implementations of the present disclosure can also make the driving decisions of the autonomous-driving vehicle easier by obtaining high-contrast and clearer images of external environment and thus provide safer traffic environments.

One embodiment provides systems and methods for providing illumination on a region of interest (RoI) for which image processing for autonomous driving operations is carried out. The system can automatically choose an appropriate illumination condition based on environmental conditions. For instance, one method entails emitting a light for a pedestrian who is likely to be within the planned trajectory of the autonomous vehicle. The light can be emitted by an appropriate light emitting device (e.g., an LED lamp), so that it can be captured by image sensing modules with high-contrast, yet still not excessively interfering to humans. The illumination may be different depending on the type of road users (e.g., pedestrian, vehicle, animal), a distance to the object, and/or a moving direction of the autonomous vehicle and/or the object.

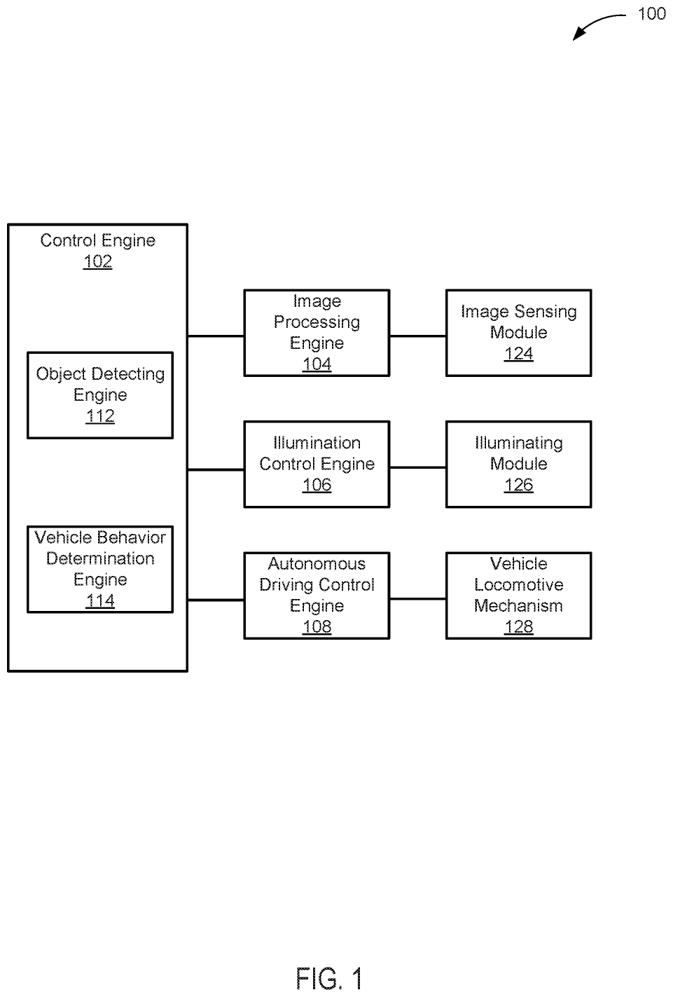

FIG. 1 is a schematic diagram depicting an example of an autonomous-driving vehicle system 100 according to an embodiment. In the example depicted in FIG. 1, the autonomous-driving vehicle system 100 includes a control engine 102, and an image processing engine 104, an illumination control engine 106, and an autonomous-driving control engine 108 coupled to the control engine 102. The autonomous-driving vehicle system 100 also includes an image sensing module 124 coupled to the image processing engine 104, an illumination module 126 coupled to the illumination control engine 106, and a vehicle locomotive mechanism 128 coupled to the autonomous-driving control engine 108.

In the example depicted in FIG. 1, the autonomous-driving vehicle system 100 is intended to represent a system primarily mounted on an autonomous-driving vehicle, which is capable of sensing its environment and navigating with a limited human input or without human input. The “vehicle” discussed in this paper typically includes a vehicle that drives on the ground, such as wheeled vehicles, such as automobiles, motorcycles, motorized or electric bikes, and may also include a vehicle that flies in the sky (e.g., drones, helicopter, airplanes, and so on). The “vehicle” discussed in this paper may or may not accommodate one or more passengers therein.

In one embodiment, the autonomous-driving vehicle includes a vehicle that controls braking and/or acceleration without real time human input. In another embodiment, the autonomous-driving vehicle includes a vehicle that controls steering without real time human input based on inputs from one or more lens mount units. In another embodiment, the autonomous-driving vehicle includes a vehicle that autonomously controls braking, acceleration, and steering without real time human input specifically for parking the vehicle at a specific parking space, such as a parking lot, a curb side of a road (e.g., parallel parking), and a home garage, and so on. Further, “real time human input” is intended to mean a human input that is needed to concurrently control movement of a non-autonomous-driving vehicle, such as gear shifting, steering control, braking control, accelerating control, crutching control, and so on.

In one embodiment, the autonomous-driving vehicle system 100 is capable of sensing its environment based on inputs from one or more imaging devices (e.g., camera) mounted on the autonomous-driving vehicle system 100. In an embodiment, the autonomous-driving vehicle system 100 is configured to analyze image data obtained from the one or more imaging devices and identify objects (e.g., traffic signals, traffic signs, road signs, other vehicles, cyclists, pedestrians, and obstacles) included in images of the analyzed image data. In one embodiment, the autonomous-driving vehicle system 100 is also capable of performing an autonomous-driving operation based on the identified objects. In an embodiment, the autonomous-driving vehicle system 100 is also capable of drive the vehicle so as to follow a traffic stream without hitting the identified objects. For example, the autonomous-driving vehicle system 100 follow traffic signals identified based on image data, follow traffic signs identified based on image data, and drive with a sufficient distance from preceding vehicles.

In the example of FIG. 1, the autonomous-driving vehicle system 100 is also capable of communicating with systems or devices connected to the autonomous-driving vehicle system 100 through a network. In an embodiment, the autonomous-driving vehicle system 100 communicates with a server via the network. For example, the autonomous-driving vehicle system 100 pulls up from the server map information (e.g., local map, parking structure map, floor plan of buildings, and etc.) of a region around the autonomous-driving vehicle. In another example, the autonomous-driving vehicle system 100 periodically notifies information of the autonomous-driving vehicle system 100 such as locations and directions thereof to the server.

In some embodiments, the network is intended to represent a variety of potentially applicable technologies. For example, the network can be used to form a network or part of a larger network. Where two components are co-located on a device, the network can include a bus or other data conduit or plane. Depending upon implementation-specific or other considerations, the network can include wired communication interfaces and wireless communication interfaces for communicating over wired or wireless communication channels. Where a first component is located on a first device and a second component is located on a second (different) device, the network can include a wireless or wired back-end network or LAN. The network can also encompass a relevant portion of a WAN or other network, if applicable. Enterprise networks can include geographically distributed LANs coupled across WAN segments. For example, a distributed enterprise network can include multiple LANs (each LAN is sometimes referred to as a Basic Service Set (BSS) in IEEE 802.11 parlance, though no explicit requirement is suggested here) separated by WAN segments. An enterprise network can also use VLAN tunneling (the connected LANs are sometimes referred to as an Extended Service Set (ESS) in IEEE 802.11 parlance, though no explicit requirement is suggested here). Depending upon implementation or other considerations, the network can include a private cloud under the control of an enterprise or third party, or a public cloud.

In an embodiment, the autonomous-driving vehicle system 100 communicates with one or more other autonomous-driving vehicle systems via the network. For example, the autonomous-driving vehicle system 100 sends information of a vehicle route of the corresponding autonomous-driving vehicle to the one or more other autonomous-driving vehicle systems, such that traffic incidents such as collisions can be prevented. In another example, the autonomous-driving vehicle system 100 commands one or more other autonomous-driving police systems to proceed to a particular location so as to avoid traffic incidents.

In the example depicted in FIG. 1, the control engine 102 is intended to represent specifically-purposed hardware and software configured to control overall operation of the autonomous-driving vehicle system 100. For example, the control engine 102 controls operations of the image processing engine 104, the illumination control engine 106, and the autonomous driving control engine 108. The control engine 102 includes an object detecting engine 112 and a vehicle behavior determination engine 114.

In the example depicted in FIG. 1, the image processing engine 104 is intended to represent specifically-purposed hardware and software configured to carry out image processing of image data of scene images generated by the imaging sensing module 124. In a specific example, the scene images include road signs, traffic signals, lane lines, other vehicles, pedestrians, buildings, and so on.

In the example depicted in FIG. 1, the imaging sensing module 124 is intended to represent specifically-purposed hardware and software configured to capture scene images and generate image data thereof. In a specific implementation, the imaging sensing module 124 includes an image sensor, such as CCD and CMOS sensors, an infrared image sensor, and so on. Depending on a specific implementation and other consideration, the imaging sensing module 124 may include two or more image sensors, and may be or may not be mounted on an autonomous-driving vehicle corresponding to the autonomous-driving vehicle system 100. For example, the imaging sensing module 124 may include one or more images sensors mounted on the autonomous-driving vehicle and one or more images sensors that are not mounted on the autonomous-driving vehicle, and rather placed at external places, such as street lamps, traffic signals, other vehicles, buildings, and so on.

In an embodiment, the image processing engine 104 is configured to identify each object included in the scene images based on image processing of the image data thereof, in accordance with an image recognition technique. In an example image recognition technique, the image processing engine 104 compares image data from a detected object with image data from a reference object(s) that are stored in advance. The stored image data, for example, can be stored in the autonomous-driving vehicle system 100 or at an external server for identification of the detected objects. For the image recognition, an applicable machine learning technology (including deep learning) is employed in a specific implementation.

In an embodiment, the image processing engine 104 is configured to generate processed image data and provide the processed image data to the control engine 102. For example, the processed image data include the image data obtained from the imaging devices and metadata of identified objects and metadata of detected objects (but not identified). In a more specific example, the metadata include a relative position (including distance) of each detected object from the autonomous-driving vehicle system 100. In another more specific example, the metadata include a model, make, year, and color of each vehicle included in a scene image, a license plate number of each vehicle included in a scene image, a height, predicted gender, predicted age, and clothes of each pedestrian included in a scene image. In another more specific example, the metadata may also include the number of passengers in one or more vehicles included in the scene image.

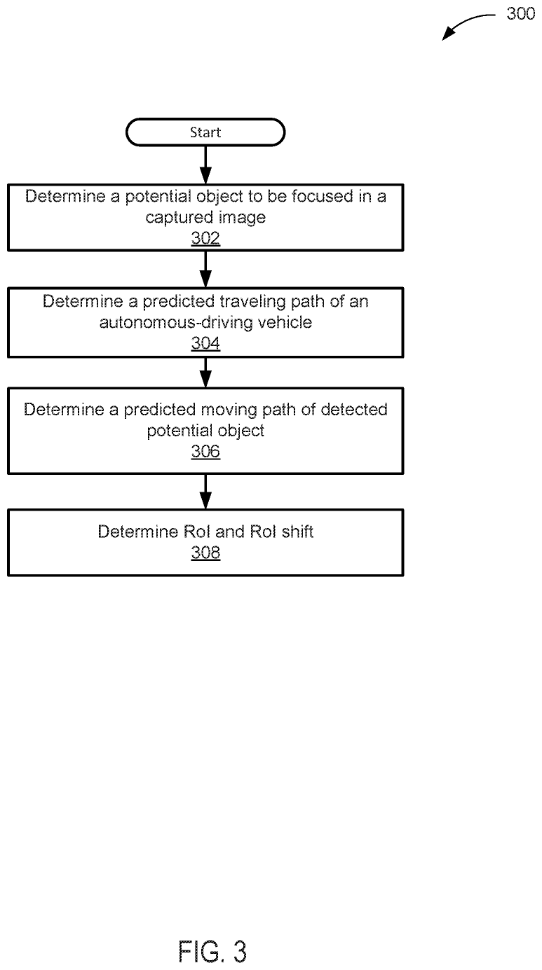

In the example depicted in FIG. 1, the illumination control engine 106 is intended to represent specifically-purposed hardware and software configured to control the illumination module 126. In some embodiments, in controlling the illumination module 126, the illumination control engine 106 may be configured to determine one or more illumination conditions of the illumination module 126. An example of a specific manner of determining an illumination condition is described below with reference to FIG. 3. For example, the illumination control engine 106 may be configured to adjust an intensity, an angle, and/or a direction of illumination generated by the illumination module 126. In another example, the illumination control engine 106 may be configured to select one or more light emitting devices of the illumination module 126 to be activated.

In the example depicted in FIG. 1, the illumination module 126 is intended to represent specifically-purposed hardware and software configured to emit light for illumination. In a specific implementation, the illumination module 126 includes one or more light emitting devices at least part of which is mounted on the autonomous-driving vehicle. The illumination module 126 may include one or more of head lights, fog lights, tail lights, and so on that are typically mounted on a vehicle, and/or include specifically-purposed light emitting device(s) for image capturing for autonomous driving operation.

In the example depicted in FIG. 1, the object detecting engine 112 is intended to represent specifically-purposed hardware and software configured to detect objects from scene images represented by image data processed by the image processing engine 104. In a specific example, the object detecting engine 112 detects objects based on a contour line (high contrast region) included in the scene images. In an embodiment, in detecting objects, the object detecting engine 112 determines a type of objects, humans, animals, buildings, vehicles, trees, traffic signals, traffic signs, road obstacles, and so on, and determines that objects determined as humans, animals, vehicles, and so on are determined as movable objects. Although objects movable by wind power such as trash, objects movable (thrown, projected, pushed, etc.) by human power such as balls, luggage, and so on, are literally “movable,” the object detecting engine 112 may exclude these “movable objects” that have no physiologic power or human-controllable locomotive power to move from the targets to be detected thereby. In some embodiments, the object detecting engine 112 is configured to determine a region of interest (RoI) for which image processing for autonomous-driving operation and illumination for better image recognition are to be specifically carried out. An example of a detailed operation of determining the RoI is described below with reference to FIG. 3.

In the example depicted in FIG. 1, the vehicle behavior determination engine 114 is intended to represent specifically-purposed hardware and software configured to determine behavior of the autonomous-driving vehicle system 100. In an embodiment, the vehicle behavior determination engine 114 autonomously determines behavior of the autonomous-driving vehicle system 100. More specifically, the vehicle behavior determination engine 114 determines a vehicle route of the autonomous-driving vehicle. In an embodiment, the vehicle route includes a global vehicle route including which road to be used and which intersection to make a turn, and so on, and/or a local vehicle route including which lane of a road to be used, which parking spot of a parking place (e.g., curb-side parallel parking space) to be used, and so on. In an embodiment, the vehicle behavior determination engine 114 determines the vehicle route based on various applicable criteria, such as a current location, a destination, traffic conditions (e.g., congestion, speed limits, number of traffic signals, etc.), weather conditions, environmental conditions (e.g., time, brightness, etc.), geographic crime rates, number of intersection turns, existence of obstacles on roads, etc. In an embodiment, the vehicle behavior determination engine 114 subordinately determines behavior of the autonomous-driving vehicle system 100 based on instructions from an external system (e.g., autonomous-driving vehicle systems of other vehicles, a traffic control server, etc.).

In the example depicted in FIG. 1, the autonomous-driving control engine 108 is intended to represent specifically-purposed hardware and software configured to perform an autonomous-driving operation of the autonomous-driving vehicle system 100 based on the determined behavior of the autonomous-driving vehicle system 100. For example, when the vehicle behavior determination engine 114 determines to change a lane on a road, the autonomous-driving control engine 108 causes the vehicle locomotive mechanism 128 to flash blinker lamps, direct wheels to the lane, and return position of the wheels after changing the lame and stop blinker lamps. For example, when the vehicle behavior determination engine 114 determines to proceed to a specific location (e.g., a parking spot), the autonomous-driving control engine 108 causes the vehicle locomotive mechanism 128 to drive to the specific location. For example, when the vehicle behavior determination engine 114 determines to take a specific route, the autonomous-driving control engine 108 causes the vehicle locomotive mechanism 128 to drive taking the specific route.

In an embodiment, the autonomous-driving control engine 108 is configured to control the vehicle locomotive mechanism 128 based on the predicted reactive movement of detected object(s). For example, when a detected object is a pedestrian and the reactive movement of the detected object is stop of walk, the autonomous-driving control engine 108 controls the vehicle locomotive mechanism 138 to drive apart from or avoid a stop position of the detected object. In another example, when a detected object is an animal and the reactive movement of the detected object is rushing in a specific direction, the autonomous-driving control engine 108 controls the vehicle locomotive mechanism 128 to drive the autonomous-driving vehicle in a direction different from the specific direction.

In the example depicted in FIG. 1, the vehicle locomotive mechanism 128 is intended to represent specifically-purposed mechanism to drive an autonomous-driving vehicle. Depending on a specific implementation and other consideration, the vehicle locomotive mechanism 128 may include an electrical power and drive unit, such as a motor, to drive the autonomous-driving vehicle, and/or a fuel-based power and drive unit such as an engine. Depending on a specific implementation and other consideration, the vehicle locomotive mechanism 128 may be controlled based on mechanical control actions triggered by the autonomous-driving control engine 108 and/or electrical signals generated by the autonomous-driving control engine 108.

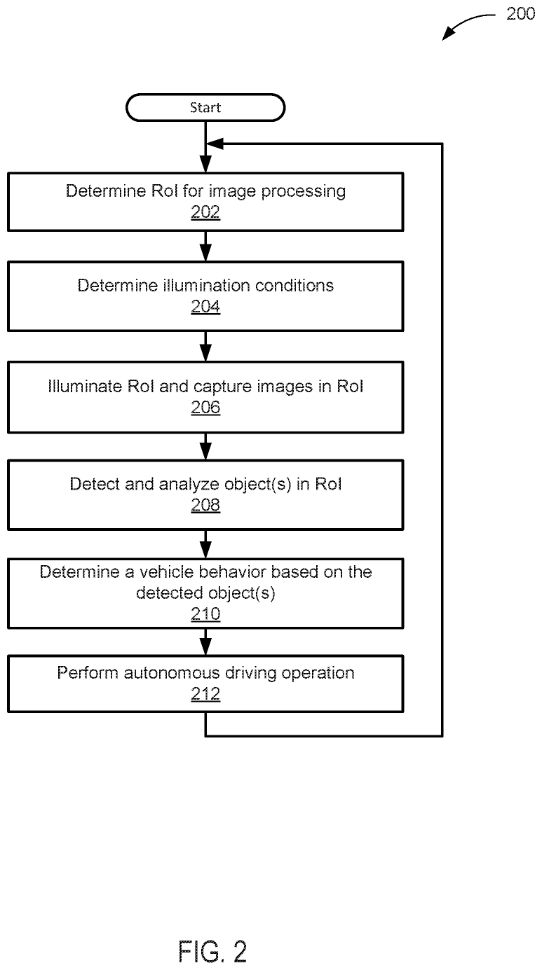

FIG. 2 depicts a flowchart 200 of an example of a method for operating an autonomous-driving vehicle system. This flowchart and other flowcharts described in this paper illustrate modules (and potentially decision points) organized in a fashion that is conducive to understanding. It should be recognized, however, that the modules can be reorganized for parallel execution, reordered, modified (changed, removed, or augmented), where circumstances permit. In the example of FIG. 2, the flowchart 200 starts at module 202, with determining an RoI for image processing for an autonomous driving operation. An applicable engine for performing image processing, such as an image processing engine (e.g., the image processing engine 104 in FIG. 1) and/or an object detecting engine (e.g., the object detecting engine 112 in FIG. 1) described in this paper, can determining the RoI for image processing. In an embodiment, an RoI is determined based on one or more images captured by an image sensing module. An example of a detailed process of determining an RoI based on one or more captured images is described below with reference to FIG. 3. In an embodiment, an RoI is determined based on a field of view (FoV) of an image sensing module with which images are to be captured for autonomous driving operation. For example, a shift of a field of view (FoV) of a camera as the camera pans and/or tilts is determined, and then the RoI and a shift of the RoI are determined such that the RoI stays within the FoV of the camera. In some embodiments, to achieve the RoI within the FoV, illumination may be also panned and/or tilted in accordance with the pan and/or tilt of the camera.

In the example of FIG. 2, the flowchart 200 continues to module 204, with determining one or more illumination conditions. An applicable engine for determining illumination conditions, such as an illumination control engine (e.g., the illumination control engine 106 in FIG. 1) described in this paper, can determine illumination conditions. In an embodiment, the illumination conditions may include one or more of an intensity of illumination, an illumination angle, and an illumination direction. In an embodiment, an intensity of illumination may be determined based on various applicable criteria, such as a type of a detected object (or a potential object to be focused) and a time-dependent distance to the detected object (or the potential object to be focused). For example, the intensity of illumination may be determined so as not to be excessively interfering to human when an detected object is a pedestrian, a human driver, etc. In another example, the intensity of illumination may be determined so as provide sufficient illumination to an object at a time-dependent distance from a light source. To obtain the time-dependent distance, the direction and speed of the object and the direction and speed of the autonomous-driving vehicle may be determined.

In an embodiment, an illumination angle may be also determined based on various applicable criteria, such as a time-dependent distance to the detected object (or the potential object to be focused). In an embodiment, an illumination direction may be also determined based on various applicable criteria, such as a relative position of the detected object (or the potential object to be focused) with respect to the autonomous-driving vehicle. For example, an illumination direction may be determined such that the illumination stays illuminating the RoI as the autonomous-driving vehicle travels. In an embodiment, the illumination may include a plurality of light emitting devices directed to different directions, and an illumination condition may include one or more of the light emitting devices to be selectively activated. For example, one or more of the light emitting devices may be selected, such that the illumination stays illuminating the RoI as the autonomous-driving vehicle travels.

In the example of FIG. 2, the flowchart 200 continues to module 206, with illuminating an RoI and capturing images in the RoI. An applicable engine for illuminating an RoI, such as an illumination control engine (e.g., the illumination control engine 106 in FIG. 1) described in this paper, can cause an applicable module such as an illuminating module (e.g., the illuminating module 126 in FIG. 1) to illuminate the RoI. Also, an applicable engine for capturing images in the RoI, such as an image sensing module (e.g., the image sensing module 124 in FIG. 1) described in this paper, can capture images in the RoI. The illumination is carried out according to the determined illumination condition as the autonomous-driving vehicle travels, such that the RoI stays illuminated. By illuminated by the illumination, more bright images may be captured by the image sending module.

In the example of FIG. 2, the flowchart 200 continues to module 208, with detecting and analyzing one or more objects in the RoI. An applicable engine for detecting and analyzing one or more objects in the RoI, such as an image processing engine (e.g., the image processing engine 104 in FIG. 1) described in this paper, can detect and analyze one or more objects in the RoI. In a situation, the detected object in the RoI may be a pedestrian, another vehicle driving by a human driver, or an animal, etc. In a situation the detected object may or may not be the same as a potential object based on which the RoI was determined.

In the example of FIG. 2, the flowchart 200 continues to module 210, with determining a vehicle behavior based on the detected one or more objects. An applicable engine for determining a vehicle behavior, such as a vehicle behavior determination engine (e.g., the vehicle behavior determination engine 114 in FIG. 1) described in this paper, can determine the vehicle behavior based on the detected one or more objects. In an embodiment, the vehicle behavior may include at least one of braking, accelerating, and steering of the autonomous-driving vehicle. In an embodiment, the vehicle behavior may include at least one of light signaling and sound signaling.

In the example of FIG. 2, the flowchart 200 continues to module 212, with performing an autonomous driving operation. An applicable engine for performing an autonomous driving operation, such as an autonomous driving control engine (e.g., the autonomous driving control engine 108 in FIG. 1) described in this paper, can perform the autonomous driving operation by controlling an applicable locomotive mechanism (e.g., the vehicle locomotive mechanism 128 in FIG. 1) of an autonomous-driving vehicle. In an embodiment, in performing an autonomous driving operation, predicted movement of the target movable traffic object(s) in response to the vehicle behavior notification is determined, and the locomotive mechanism of the autonomous-driving vehicle is controlled based on the predicted movement of the detected object(s). In the example of FIG. 2, the flowchart 200 returns to module 202, and module 202 through module 212 are repeated.

FIG. 3 depicts a flowchart 300 of an example of a method for determining a RoI for processing images for an autonomous driving operation. In the example of FIG. 3, the flowchart 300 starts at module 302, with detecting a potential object to be focused in a captured image. An applicable engine for determining a potential object to be focused in a captured image, such as an object detecting engine (e.g., the object detecting engine 112 in FIG. 1) described in this paper, can determine a potential object to be focused in a captured image. In an embodiment, the potential object may be an object detected in a captured image such as a pedestrian. In an embodiment, the potential object may be a predicted object that is likely to exist based on an image captured under a non-optimal illumination condition. For example, the potential object may be a stray cat that is likely to exist based on eye reflection in a dark area.

In the example of FIG. 3, the flowchart 300 continues to module 304, with determining a predicted traveling path of an autonomous-driving vehicle. An applicable engine for determining a predicted traveling path of an autonomous-driving vehicle, such as a vehicle behavior determination engine (e.g., the vehicle behavior determination engine 114 in FIG. 1) described in this paper, can determine the predicted traveling path of the autonomous-driving vehicle. In an embodiment, the predicted traveling path may be determined based on a vehicle behavior of the autonomous-driving vehicle. For example, when a vehicle route of the autonomous-driving vehicle is determined, a predicted traveling path of the autonomous-driving vehicle may be determined based on the vehicle route.

In the example of FIG. 3, the flowchart 300 continues to module 306, with determining predicted moving paths of detected one or more objects. An applicable engine for determining predicted moving paths of detected one or more objects, such as an object detecting engine (e.g., the object detecting engine 112 in FIG. 1) described in this paper, can determine the predicted moving paths of the detected one or more objects. In an embodiment, a predicted moving path of a detected object includes a local pedestrian route such as what positions of a sidewalk a pedestrian passes, what positions of a crosswalk a pedestrian passes, when the detected object is a pedestrian. In an embodiment, a predicted moving path of a detected object includes a local vehicle route such as which lane of a road is going to be used, which parking spot of a parking place (e.g., curb-side parallel parking space) is going to be used, and so on, when the detected object is a vehicle. In an embodiment, a predicted moving path of a detected object includes a local animal route, when the detected object is an animal. In an embodiment, a predicted moving path of a detected object is determined based on various applicable criteria.

For example, when the detected object is a pedestrian, the criteria to determine the predicted moving path may include a current pedestrian state, such as a current walking speed, a current orientation of the body, a current direction of the face, a current direction of the eyes, and so on, and a current environmental state, such as state of traffic signals therearound, state of other pedestrians and vehicles therearound, and so on. In another example, when the detected object is a vehicle, the criteria to determine the predicted moving path may include a current vehicle state, such as a current driving speed, a current power (engine) state (e.g., on or off), a current orientation of the vehicle, a current acceleration (or deceleration) of the vehicle, a current lamp state (e.g., blinker lamps and/or tail lamps), a current direction of tires, a current position of the vehicle on road (e.g., lane), and so on, and a current environmental state, such as state of traffic signals therearound, state of other vehicles and other pedestrians therearound, and so on. In another example, when the detected object is an animal, the criteria to determine the predicted moving path may include a type of the animal, previous moving paths taken by animals, and so on.

In the example of FIG. 3, the flowchart 300 continues to module 308, with determining an RoI and a shift of the RoI. An applicable engine for determining an RoI and a shift of the RoI, such as an object detecting engine (e.g., the object detecting engine 112 in FIG. 1) and/or an illumination control engine (e.g., the illumination control engine 106 in FIG. 1) described in this paper, can determine the RoI and the shift of the RoI. In an embodiment, the RoI and a shift of the RoI based on the predicted traveling path of the autonomous-driving vehicle and the predicted moving path of the potential object. The RoI and a shift of the RoI may be determined, such that the potential object stays within the RoI as the autonomous-driving vehicle travels.

The foregoing description of the present invention has been provided for the purposes of illustration and description. It is not intended to be exhaustive or to limit the invention to the precise forms disclosed. The breadth and scope of the present invention should not be limited by any of the above-described exemplary embodiments. Many modifications and variations will be apparent to the practitioner skilled in the art. The modifications and variations include any relevant combination of the disclosed features. The embodiments were chosen and described in order to best explain the principles of the invention and its practical application, thereby enabling others skilled in the art to understand the invention for various embodiments and with various modifications that are suited to the particular use contemplated. It is intended that the scope of the invention be defined by the following claims and their equivalence.

### Hardware Implementation

The techniques described herein are implemented by one or more special-purpose computing devices. The special-purpose computing devices may be hard-wired to perform the techniques, or may include circuitry or digital electronic devices such as one or more application-specific integrated circuits (ASICs) or field programmable gate arrays (FPGAs) that are persistently programmed to perform the techniques, or may include one or more hardware processors programmed to perform the techniques pursuant to program instructions in firmware, memory, other storage, or a combination. Such special-purpose computing devices may also combine custom hard-wired logic, ASICs, or FPGAs with custom programming to accomplish the techniques. The special-purpose computing devices may be desktop computer systems, server computer systems, portable computer systems, handheld devices, networking devices or any other device or combination of devices that incorporate hard-wired and/or program logic to implement the techniques.

Computing device(s) are generally controlled and coordinated by operating system software, such as iOS, Android, Chrome OS, Windows XP, Windows Vista, Windows 7, Windows 8, Windows 10, Windows Server, Windows CE, Unix, Linux, SunOS, Solaris, iOS, Blackberry OS, VxWorks, or other compatible operating systems. In other embodiments, the computing device may be controlled by a proprietary operating system. Conventional operating systems control and schedule computer processes for execution, perform memory management, provide file system, networking, I/O services, and provide a user interface functionality, such as a graphical user interface (“GUI”), among other things.

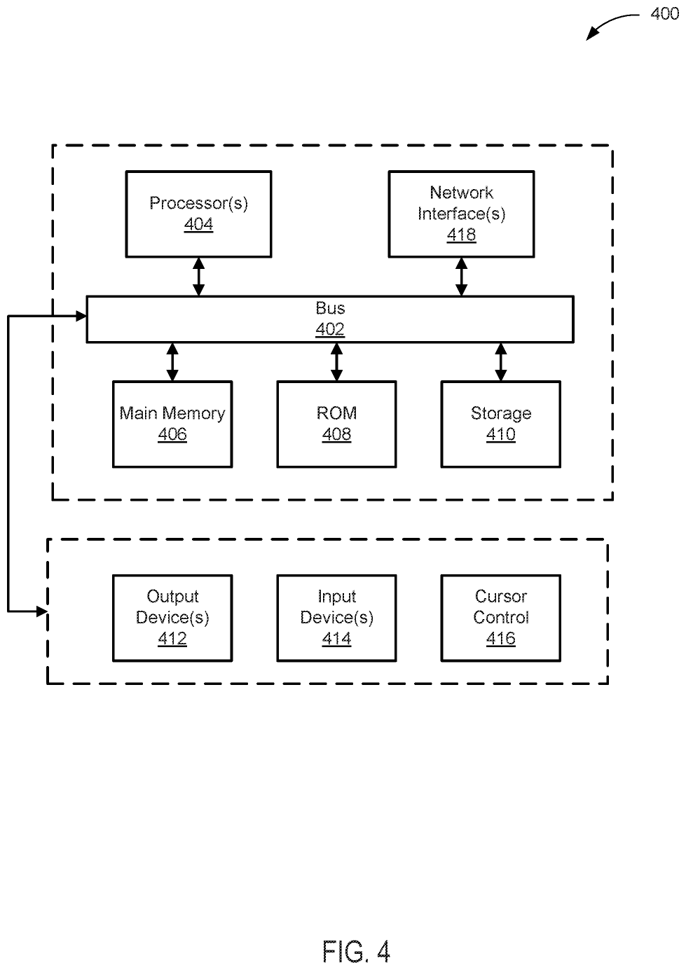

FIG. 4 is a block diagram that illustrates a computer system 400 upon which any of the embodiments described herein may be implemented. The computer system 400 includes a bus 402 or other communication mechanism for communicating information, one or more hardware processors 404 coupled with bus 402 for processing information. Hardware processor(s) 404 may be, for example, one or more general purpose microprocessors.

The computer system 400 also includes a main memory 406, such as a random access memory (RAM), cache and/or other dynamic storage devices, coupled to bus 402 for storing information and instructions to be executed by processor 404. Main memory 406 also may be used for storing temporary variables or other intermediate information during execution of instructions to be executed by processor 404. Such instructions, when stored in storage media accessible to processor 404, render computer system 400 into a special-purpose machine that is customized to perform the operations specified in the instructions.

The computer system 400 further includes a read only memory (ROM) 408 or other static storage device coupled to bus 402 for storing static information and instructions for processor 404. A storage device 410, such as a magnetic disk, optical disk, or USB thumb drive (Flash drive), etc., is provided and coupled to bus 402 for storing information and instructions.

The computer system 400 may be coupled via bus 402 to output device(s) 412, such as a cathode ray tube (CRT) or LCD display (or touch screen), for displaying information to a computer user. Input device(s) 414, including alphanumeric and other keys, are coupled to bus 402 for communicating information and command selections to processor 404. Another type of user input device is cursor control 416, such as a mouse, a trackball, or cursor direction keys for communicating direction information and command selections to processor 404 and for controlling cursor movement on display 412. This input device typically has two degrees of freedom in two axes, a first axis (e.g., x) and a second axis (e.g., y), that allows the device to specify positions in a plane. In some embodiments, the same direction information and command selections as cursor control may be implemented via receiving touches on a touch screen without a cursor.

The computing system 400 may include a user interface module to implement a GUI that may be stored in a mass storage device as executable software codes that are executed by the computing device(s). This and other modules may include, by way of example, components, such as software components, object-oriented software components, class components and task components, processes, functions, attributes, procedures, subroutines, segments of program code, drivers, firmware, microcode, circuitry, data, databases, data structures, tables, arrays, and variables.

In general, the word “module,” as used herein, refers to logic embodied in hardware or firmware, or to a collection of software instructions, possibly having entry and exit points, written in a programming language, such as, for example, Java, C or C++. A software module may be compiled and linked into an executable program, installed in a dynamic link library, or may be written in an interpreted programming language such as, for example, BASIC, Perl, or Python. It will be appreciated that software modules may be callable from other modules or from themselves, and/or may be invoked in response to detected events or interrupts. Software modules configured for execution on computing devices may be provided on a computer readable medium, such as a compact disc, digital video disc, flash drive, magnetic disc, or any other tangible medium, or as a digital download (and may be originally stored in a compressed or installable format that requires installation, decompression or decryption prior to execution). Such software code may be stored, partially or fully, on a memory device of the executing computing device, for execution by the computing device. Software instructions may be embedded in firmware, such as an EPROM. It will be further appreciated that hardware modules may be comprised of connected logic units, such as gates and flip-flops, and/or may be comprised of programmable units, such as programmable gate arrays or processors. The modules or computing device functionality described herein are preferably implemented as software modules, but may be represented in hardware or firmware. Generally, the modules described herein refer to logical modules that may be combined with other modules or divided into sub-modules despite their physical organization or storage.

The computer system 400 may implement the techniques described herein using customized hard-wired logic, one or more ASICs or FPGAs, firmware and/or program logic which in combination with the computer system causes or programs computer system 400 to be a special-purpose machine. According to one embodiment, the techniques herein are performed by computer system 400 in response to processor(s) 404 executing one or more sequences of one or more instructions contained in main memory 406. Such instructions may be read into main memory 406 from another storage medium, such as storage device 410. Execution of the sequences of instructions contained in main memory 406 causes processor(s) 404 to perform the process steps described herein. In alternative embodiments, hard-wired circuitry may be used in place of or in combination with software instructions.

The term “non-transitory media,” and similar terms, as used herein refers to any media that store data and/or instructions that cause a machine to operate in a specific fashion. Such non-transitory media may comprise non-volatile media and/or volatile media. Non-volatile media includes, for example, optical or magnetic disks, such as storage device 410. Volatile media includes dynamic memory, such as main memory 406. Common forms of non-transitory media include, for example, a floppy disk, a flexible disk, hard disk, solid state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge, and networked versions of the same.

Non-transitory media is distinct from but may be used in conjunction with transmission media. Transmission media participates in transferring information between non-transitory media. For example, transmission media includes coaxial cables, copper wire and fiber optics, including the wires that comprise bus 402. Transmission media can also take the form of acoustic or light waves, such as those generated during radio-wave and infra-red data communications.

Various forms of media may be involved in carrying one or more sequences of one or more instructions to processor 404 for execution. For example, the instructions may initially be carried on a magnetic disk or solid state drive of a remote computer. The remote computer can load the instructions into its dynamic memory and send the instructions over a telephone line using a modem. A modem local to computer system 400 can receive the data on the telephone line and use an infra-red transmitter to convert the data to an infra-red signal. An infra-red detector can receive the data carried in the infra-red signal and appropriate circuitry can place the data on bus 402. Bus 402 carries the data to main memory 406, from which processor 404 retrieves and executes the instructions. The instructions received by main memory 406 may retrieves and executes the instructions. The instructions received by main memory 406 may optionally be stored on storage device 410 either before or after execution by processor 404.

The computer system 400 also includes a communication interface 418 coupled to bus 402. Communication interface 418 provides a two-way data communication coupling to one or more network links that are connected to one or more local networks. For example, communication interface 418 may be an integrated services digital network (ISDN) card, cable modem, satellite modem, or a modem to provide a data communication connection to a corresponding type of telephone line. As another example, communication interface 418 may be a local area network (LAN) card to provide a data communication connection to a compatible LAN (or WAN component to communicated with a WAN). Wireless links may also be implemented. In any such implementation, communication interface 418 sends and receives electrical, electromagnetic or optical signals that carry digital data streams representing various types of information.

A network link typically provides data communication through one or more networks to other data devices. For example, a network link may provide a connection through local network to a host computer or to data equipment operated by an Internet Service Provider (ISP). The ISP in turn provides data communication services through the world wide packet data communication network now commonly referred to as the “Internet”. Local network and Internet both use electrical, electromagnetic or optical signals that carry digital data streams. The signals through the various networks and the signals on network link and through communication interface 418, which carry the digital data to and from computer system 400, are example forms of transmission media.

The computer system 400 can send messages and receive data, including program code, through the network(s), network link and communication interface 418. In the Internet example, a server might transmit a requested code for an application program through the Internet, the ISP, the local network and the communication interface 418.

The received code may be executed by processor 404 as it is received, and/or stored in storage device 410, or other non-volatile storage for later execution.

Each of the processes, methods, and algorithms described in the preceding sections may be embodied in, and fully or partially automated by, code modules executed by one or more computer systems or computer processors comprising computer hardware. The processes and algorithms may be implemented partially or wholly in application-specific circuitry.

The various features and processes described above may be used independently of one another, or may be combined in various ways. All possible combinations and sub-combinations are intended to fall within the scope of this disclosure. In addition, certain method or process blocks may be omitted in some implementations. The methods and processes described herein are also not limited to any particular sequence, and the blocks or states relating thereto can be performed in other sequences that are appropriate. For example, described blocks or states may be performed in an order other than that specifically disclosed, or multiple blocks or states may be combined in a single block or state. The example blocks or states may be performed in serial, in parallel, or in some other manner. Blocks or states may be added to or removed from the disclosed example embodiments. The example systems and components described herein may be configured differently than described. For example, elements may be added to, removed from, or rearranged compared to the disclosed example embodiments.

Conditional language, such as, among others, “can,” “could,” “might,” or “may,” unless specifically stated otherwise, or otherwise understood within the context as used, is generally intended to convey that certain embodiments include, while other embodiments do not include, certain features, elements and/or steps. Thus, such conditional language is not generally intended to imply that features, elements and/or steps are in any way required for one or more embodiments or that one or more embodiments necessarily include logic for deciding, with or without user input or prompting, whether these features, elements and/or steps are included or are to be performed in any particular embodiment.

Any process descriptions, elements, or blocks in the flow diagrams described herein and/or depicted in the attached figures should be understood as potentially representing modules, segments, or portions of code which include one or more executable instructions for implementing specific logical functions or steps in the process. Alternate implementations are included within the scope of the embodiments described herein in which elements or functions may be deleted, executed out of order from that shown or discussed, including substantially concurrently or in reverse order, depending on the functionality involved, as would be understood by those skilled in the art.

It should be emphasized that many variations and modifications may be made to the above-described embodiments, the elements of which are to be understood as being among other acceptable examples. All such modifications and variations are intended to be included herein within the scope of this disclosure. The foregoing description details certain embodiments of the invention. It will be appreciated, however, that no matter how detailed the foregoing appears in text, the invention can be practiced in many ways. As is also stated above, it should be noted that the use of particular terminology when describing certain features or aspects of the invention should not be taken to imply that the terminology is being re-defined herein to be restricted to including any specific characteristics of the features or aspects of the invention with which that terminology is associated. The scope of the invention should therefore be construed in accordance with the appended claims and any equivalents thereof.

### Engines, Components, and Logic

Certain embodiments are described herein as including logic or a number of components, engines, or mechanisms. Engines may constitute either software engines (e.g., code embodied on a machine-readable medium) or hardware engines. A “hardware engine” is a tangible unit capable of performing certain operations and may be configured or arranged in a certain physical manner. In various example embodiments, one or more computer systems (e.g., a standalone computer system, a client computer system, or a server computer system) or one or more hardware engines of a computer system (e.g., a processor or a group of processors) may be configured by software (e.g., an application or application portion) as a hardware engine that operates to perform certain operations as described herein.

In some embodiments, a hardware engine may be implemented mechanically, electronically, or any suitable combination thereof. For example, a hardware engine may include dedicated circuitry or logic that is permanently configured to perform certain operations. For example, a hardware engine may be a special-purpose processor, such as a Field-Programmable Gate Array (FPGA) or an Application Specific Integrated Circuit (ASIC). A hardware engine may also include programmable logic or circuitry that is temporarily configured by software to perform certain operations. For example, a hardware engine may include software executed by a general-purpose processor or other programmable processor. Once configured by such software, hardware engines become specific machines (or specific components of a machine) uniquely tailored to perform the configured functions and are no longer general-purpose processors. It will be appreciated that the decision to implement a hardware engine mechanically, in dedicated and permanently configured circuitry, or in temporarily configured circuitry (e.g., configured by software) may be driven by cost and time considerations.

Accordingly, the phrase “hardware engine” should be understood to encompass a tangible entity, be that an entity that is physically constructed, permanently configured (e.g., hardwired), or temporarily configured (e.g., programmed) to operate in a certain manner or to perform certain operations described herein. As used herein, “hardware-implemented engine” refers to a hardware engine. Considering embodiments in which hardware engines are temporarily configured (e.g., programmed), each of the hardware engines need not be configured or instantiated at any one instance in time. For example, where a hardware engine comprises a general-purpose processor configured by software to become a special-purpose processor, the general-purpose processor may be configured as respectively different special-purpose processors (e.g., comprising different hardware engines) at different times. Software accordingly configures a particular processor or processors, for example, to constitute a particular hardware engine at one instance of time and to constitute a different hardware engine at a different instance of time.

Hardware engines can provide information to, and receive information from, other hardware engines. Accordingly, the described hardware engines may be regarded as being communicatively coupled. Where multiple hardware engines exist contemporaneously, communications may be achieved through signal transmission (e.g., over appropriate circuits and buses) between or among two or more of the hardware engines. In embodiments in which multiple hardware engines are configured or instantiated at different times, communications between such hardware engines may be achieved, for example, through the storage and retrieval of information in memory structures to which the multiple hardware engines have access. For example, one hardware engine may perform an operation and store the output of that operation in a memory device to which it is communicatively coupled. A further hardware engine may then, at a later time, access the memory device to retrieve and process the stored output. Hardware engines may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented engines that operate to perform one or more operations or functions described herein. As used herein, “processor-implemented engine” refers to a hardware engine implemented using one or more processors.

Similarly, the methods described herein may be at least partially processor-implemented, with a particular processor or processors being an example of hardware. For example, at least some of the operations of a method may be performed by one or more processors or processor-implemented engines. Moreover, the one or more processors may also operate to support performance of the relevant operations in a “cloud computing” environment or as a “software as a service” (SaaS). For example, at least some of the operations may be performed by a group of computers (as examples of machines including processors), with these operations being accessible via a network (e.g., the Internet) and via one or more appropriate interfaces (e.g., an Application Program Interface (API)).

The performance of certain of the operations may be distributed among the processors, not only residing within a single machine, but deployed across a number of machines. In some example embodiments, the processors or processor-implemented engines may be located in a single geographic location (e.g., within a home environment, an office environment, or a server farm). In other example embodiments, the processors or processor-implemented engines may be distributed across a number of geographic locations.

### Language

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Although an overview of the subject matter has been described with reference to specific example embodiments, various modifications and changes may be made to these embodiments without departing from the broader scope of embodiments of the present disclosure. Such embodiments of the subject matter may be referred to herein, individually or collectively, by the term “invention” merely for convenience and without intending to voluntarily limit the scope of this application to any single disclosure or concept if more than one is, in fact, disclosed.

The embodiments illustrated herein are described in sufficient detail to enable those skilled in the art to practice the teachings disclosed. Other embodiments may be used and derived therefrom, such that structural and logical substitutions and changes may be made without departing from the scope of this disclosure. The Detailed Description, therefore, is not to be taken in a limiting sense, and the scope of various embodiments is defined only by the appended claims, along with the full range of equivalents to which such claims are entitled.

It will be appreciated that an “engine,” “system,” “data store,” and/or “database” may comprise software, hardware, firmware, and/or circuitry. In one example, one or more software programs comprising instructions capable of being executable by a processor may perform one or more of the functions of the engines, data stores, databases, or systems described herein. In another example, circuitry may perform the same or similar functions. Alternative embodiments may comprise more, less, or functionally equivalent engines, systems, data stores, or databases, and still be within the scope of present embodiments. For example, the functionality of the various systems, engines, data stores, and/or databases may be combined or divided differently.

“Open source” software is defined herein to be source code that allows distribution as source code as well as compiled form, with a well-publicized and indexed means of obtaining the source, optionally with a license that allows modifications and derived works.

The data stores described herein may be any suitable structure (e.g., an active database, a relational database, a self-referential database, a table, a matrix, an array, a flat file, a documented-oriented storage system, a non-relational No-SQL system, and the like), and may be cloud-based or otherwise.

As used herein, the term “or” may be construed in either an inclusive or exclusive sense. Moreover, plural instances may be provided for resources, operations, or structures described herein as a single instance. Additionally, boundaries between various resources, operations, engines, engines, and data stores are somewhat arbitrary, and particular operations are illustrated in a context of specific illustrative configurations. Other allocations of functionality are envisioned and may fall within a scope of various embodiments of the present disclosure. In general, structures and functionality presented as separate resources in the example configurations may be implemented as a combined structure or resource. Similarly, structures and functionality presented as a single resource may be implemented as separate resources. These and other variations, modifications, additions, and improvements fall within a scope of embodiments of the present disclosure as represented by the appended claims. The specification and drawings are, accordingly, to be regarded in an illustrative rather than a restrictive sense.

Conditional language, such as, among others, “can,” “could,” “might,” or “may,” unless specifically stated otherwise, or otherwise understood within the context as used, is generally intended to convey that certain embodiments include, while other embodiments do not include, certain features, elements and/or steps. Thus, such conditional language is not generally intended to imply that features, elements and/or steps are in any way required for one or more embodiments or that one or more embodiments necessarily include logic for deciding, with or without user input or prompting, whether these features, elements and/or steps are included or are to be performed in any particular embodiment.

Although the invention has been described in detail for the purpose of illustration based on what is currently considered to be the most practical and preferred implementations, it is to be understood that such detail is solely for that purpose and that the invention is not limited to the disclosed implementations, but, on the contrary, is intended to cover modifications and equivalent arrangements that are within the spirit and scope of the appended claims. For example, it is to be understood that the present invention contemplates that, to the extent possible, one or more features of any embodiment can be combined with one or more features of any other embodiment.

What is claimed is:

1. A system for an autonomous-driving vehicle, comprising:
one or more processors; and
memory storing instructions that, when executed by the one or more processors, cause the one or more processors to:
determine a region of interest (RoI) for processing images for an autonomous driving operation;
determine an illumination condition for illuminating the determined RoI based on the determined RoI; and
cause illumination to illuminate the determined RoI according to the determined illumination condition as the autonomous-driving vehicle travels.

2. The system of claim 1, wherein the instructions cause the one or more processors to:
cause an image to be captured;
determine a potential object to be focused in the captured image;
determine a predicted traveling path of the autonomous-driving vehicle;
determine a predicted moving path of the potential object; and
determine the RoI and a shift of the RoI based on the predicted traveling path of the autonomous-driving vehicle and the predicted moving path of the potential object, such that the potential object stays within the RoI.

3. The system of claim 2, wherein the instructions cause the one or more processors to:
determine a type of the potential object to be focused; and
determine an intensity of illumination based on the type of the potential object.

4. The system of claim 2, wherein the instructions cause the one or more processors to:
determine a distance to the potential object; and
determine at least one of an intensity of illumination and an illumination angle based on the distance to the potential object.

5. The system of claim 2, wherein the instructions cause the one or more processors to determine an illumination direction, such that the illumination stays illuminating the RoI.

6. The system of claim 2, wherein the illumination includes a plurality of light emitting devices directed to different directions, and the instructions cause the one or more processors to select one or more light emitting devices to be activated from the plurality of light emitting devices, such that the illumination stays illuminating the RoI.

7. The system of claim 1, wherein the instructions cause the one or more processors to:
determine a shift of a field of view (FoV) of a camera as the camera pans and/or tilts; and
determine the RoI and a shift of the RoI, such that the RoI stays within the FoV of the camera.

8. The system of claim 1, wherein the instructions cause the one or more processors to:
images in the RoI illuminated according to the determined illumination condition to be captured;
detect one or more objects in the RoI;
determine a vehicle behavior based on the one or more detected objects; and
perform an autonomous driving operation according to the determined vehicle behavior.

9. The system of claim 1, wherein the vehicle behavior includes at least one of braking, accelerating, and steering of the autonomous-driving vehicle.

10. The system of claim 1, wherein the vehicle behavior includes at least one of light signaling and sound signaling.

11. A computer-implemented method performed in an autonomous-driving vehicle comprising:
determining a region of interest (RoI) for processing images for an autonomous driving operation;
determining an illumination condition for illuminating the determined RoI based on the determined RoI; and
illuminating the determined RoI according to the determined illumination condition as the autonomous-driving vehicle travels.

12. The computer-implemented method of claim 11, wherein the determining the RoI for processing images for the autonomous driving operation comprises:
capturing an image;
determining a potential object to be focused in the captured image;
determining a predicted traveling path of the autonomous-driving vehicle;
determining a predicted moving path of the potential object; and
determining the RoI and a shift of the RoI based on the predicted traveling path of the autonomous-driving vehicle and the predicted moving path of the potential object, such that the potential object stays within the RoI.

13. The computer-implemented method of claim 12, wherein
the determining the potential object to be focused in the captured image comprises determining a type of the potential object to be focused, and
the determining the illumination condition comprises determining an intensity of illumination based on the type of the potential object.

14. The computer-implemented method of claim 12, wherein
the determining the RoI for processing images for the autonomous driving operation further comprises determining a distance to the potential object, and
the determining the illumination condition comprises determining at least one of an intensity of illumination and an illumination angle based on the distance to the potential object.

15. The computer-implemented method of claim 12, wherein
the determining the illumination condition comprises determining an illumination direction, such that the illumination stays illuminating the RoI.

16. The computer-implemented method of claim 12, wherein
illumination includes a plurality of light emitting devices directed to different directions, and
the determining the illumination condition comprises selecting one or more light emitting devices to be activated from the plurality of light emitting devices, such that the illumination stays illuminating the RoI.

17. The computer-implemented method of claim 11, wherein the determining the RoI for processing images for the autonomous driving operation comprises:
determining a shift of a field of view (FoV) of a camera as the camera pans and/or tilts; and
determining the RoI and a shift of the RoI, such that the RoI stays within the FoV of the camera.

18. The computer-implemented method of claim 11, further comprising:
capturing images in the RoI illuminated according to the determined illumination condition;
detecting one or more objects in the RoI;
determining a vehicle behavior based on the one or more detected objects; and
performing an autonomous driving operation according to the determined vehicle behavior.

19. The computer-implemented method of claim 17, wherein the vehicle behavior includes at least one of braking, accelerating, and steering of the autonomous-driving vehicle.

20. The computer-implemented method of claim 17, wherein the vehicle behavior includes at least one of light signaling and sound signaling.
